(19) United States
(12) Patent Application Publication
(10) Pub. No.: US 2009/0093149 A1
(43) Pub. Date: Apr. 9, 2009

(54) ELECTRICAL CONNECTOR SYSTEM WITH TWO PART HOUSING

(75) Inventors: Danna A. Mancini, Worcester, MA (US); Allyssa M. Skidmore, Fitchburg, MA (US); Liam Holmes, County Cork (IE)

Correspondence Address: Vern Maine & Associates, 100 MAIN STREET, P O BOX 3445, NASHUA, NH, 03061-3445, US

(73) Assignee: ANDERSON POWER PRODUCTS, INC., Sterling, MA (US)

(21) Appl. No.: 11/869,132

(22) Filed: Oct. 9, 2007

(51) Int. Cl. H01R 13/62

(52) U.S. Cl. 439/259

(57) ABSTRACT

A connector housing for flat wiping electrical contacts, and methods for making and using it, where a housing has front and backside components formed and assembled so as to define a passageway thorough it with spring slots in the sidewalls for holding a leaf spring. The parting line between the components intersects the spring slots. The components are assembled with a flat wiping contact leaf spring having been placed between them with its supporting tabs in the spring slot so as to be confined in the spring slots by the step of assembling. The housing face has chin and hood structure associated with flat wiping contacts, configured for both straight in and rotational connecting motion.

### FIELD OF THE INVENTION

The present invention relates to a system and method of assembling electrical connectors, and more particularly to flat wiping electrical contact connectors with leaf springs for contact pressure enclosed between front and back end components.

### BACKGROUND OF THE INVENTION

Electrical connectors, including flat wiping contact connectors, are well known in the art. Representative examples of connectors include the connectors manufactured and sold by the Anderson Power Product Division of IDEAL Corporation and other well-known manufacturers.

Flat wiping contact technology as been an industry standard for many years for applications such electrical power connections for materials handling trucks. Single pole and dual pole flat wiping contact connectors such as for storage battery connections are common.

Most manufacturers who produce flat wiping connectors use the same method. A plastic housing is molded with a passageway or channel through the housing having a large backside opening intended for a conductor and a more defined front end opening for making the electrical connection to a mating connector. The passageway is configured with sidewall slots for locating and retaining a leaf spring that in turn retains the contact and provides the necessary wiping pressure for the contact when mated to another connector.

The commonly used method of assembly is to insert the spring into the housing through the large backside opening where it is usually locked into position in its slots by cold forming (staking) a portion of the plastic housing up behind the back end of the spring. External of the housing, a flat wiping contact is mated to a suitable conductor. The contact is then installed in the housing through the large back end opening, being slid forward until it latches over the front end of the spring.

Referring to prior art FIGS. 1A-1B, an example of a prior art housing illustrates a perspective view of a single pole housing 10 for a flat wiping connector, sectioned to reveal the interior details.

Backend opening 12 and front end opening 14 define a passageway or channel through housing 10. The front end in this case is configured as a hermaphroditic or genderless connector, with complimentary chin 15 and U-shaped hood 17 structure able to be connected to another identical connector that is rotated 180 degrees, so that the contact surfaces engage properly; as is illustrated in prior art FIG. 10. The opposing offset chins 15 align during connecting to enclose the engaged contacts 32 and the U-shaped hoods 17 on each of the mating connectors act to longitudinally and rotationally align and accept the opposing connector chin 15 in a straight-in connecting motion. The U-shaped hood restricts this type connector to only a straight-in connecting motion. The front views of two such connectors in prior art FIG. 11 well illustrates this limitation.

Referring again to FIG. 1A, leaf spring 16 is retained by spring base extensions 18 held in two opposing spring pockets or slots 20 (only one shown) proximate and parallel to floor 24. Spring slots 20 are clearly configured to be open to or accessible from the backend opening 12 for spring insertion. The leaf spring is inserted through back end opening 12 so that extensions 18 slide into slots 20. The spring is retained in its final position in slots 20 by spring stake 26, driven upward by external pressure through floor 24, just aft of the base of the spring. The leaf spring is locked in this position with its cantilevered forward end extending past barrier wall 22 and biased upwards away from floor 24.

Referring to FIG. 1B for the description of assembly; contact 30 consists of a front end wiping surface 32, terminated by spring hook 34, and a back end conductor receiver 36. (The conductor is not shown.) Contact 30 is installed by being inserted into backend opening 12 so that the front end wiping surface 32 passed under barrier wall 22, riding along on upwardly biased leaf spring 16 until spring hook 34 latches or snaps over the forward edge or end of spring 16. The housing is dimensionally configured so that the forward end of conductor receiver 36 abuts barrier wall 22 at this point, whereby contact 30 is locked in its position, restrained from further forward or aft motion and limited to only vertical motion by compression of leaf spring 16.

Thereafter in operation, floating action provided by spring 16 enables contact 30 to be depressed sufficiently during mating with another opposing connector to accept the slight vertical displacement caused by the wiping motion that brings the two opposing contacts into a compressive engagement of their respective wiping surfaces 32 through which electrical current is passed.

This connector design and methodology has one major drawback. Since the staking is accomplished by deforming housing material behind the spring, multi-pole housing configurations are limited to a single horizontal row. For additional rows assembled vertically, the bottom of the contact opening is not accessible for staking.

An exception to the illustrated prior art design and practice is where a product produced by one manufacturer incorporates a spring that is inserted from the front of the connector housing to a stop position within slots preventing further aft motion. The contact itself, once latched over the front edge of the spring, restrains it from forward motion. This design eliminates the need for staking. This design can be more easily adapted to create multi-row connectors.

Another exception to the illustrated prior art design and practice is where the plastic housing is manufactured in two separate pieces, an upper half and a lower half. The design may be described as a housing that is split in a horizontal plane to lay open the passageway or channel. In this embodiment the springs are able to be dropped into pockets in the lower half, and are trapped there when the top half is installed onto the bottom half.

Other aspects, problems and shortcomings of the background art will be readily apparent when considered in light of the invention illustrated, described and claimed herein.

### BRIEF SUMMARY OF THE INVENTION

The invention, simply stated, relates to a connector housing for flat wiping electrical contacts, and methods for making and using it, where a housing has front and back end components formed and assembled so as to define one or more passageways through it for installing flat wiping contacts, with closed ended spring slots recessed in the sidewalls for holding a leaf spring for operating the flat wiping contact. The surface area of contact between the front end and back end components of a housing of the invention is characterized for this disclosure as a parting line wherever the context admits, such as where it is viewed in cross section. The parting line between the front and back end components intersects the spring slots so that assembly of the front and back into a unitary housing or conductor shell necessarily completes the formation of the closed end spring slots. The components are assembled with a flat wiping contact leaf spring having been placed between them with its supporting tabs in the open spring slot so as to be then confined in the spring slots by the step of assembling, which closes the spring slots. The housing face may have chin and hood structure commonly associated with flat wiping contacts and genderless connectors, but here configured with clearances for both straight in and rotational connecting motions.

In one aspect, there is a method for assembling a connector shell for flat wiping electrical contacts that includes forming a back end component with at least one backside opening for an electrical conductor; forming a front end component with at least one frontside opening for exposing a flat wiping electrical contact; then placing at least one leaf spring suitable for operating a flat wiping electrical contact between the back end component and the front end component; and then assembling the back end component to the front end component to form a unitary housing so as to define between the backside opening and the frontside opening a passageway with sidewalls with opposing spring slots recessed in the side walls, so that the leaf spring is retained in position by the spring slots. There is a parting line where the back end and front end components meet, that intersects the spring slots so they are closed by assembly of the housing.

The back end and front end components may be secured together by at least one from among, or from other than, the group of means of securing comprising: interference fit, snap lock fit, mechanical fastener, adhesive, and welding. The components may have keying structure for assembly, where the step of assembling them uses the keying structure for alignment.

In another aspect, the back end component may have the spring slots, but with open forward ends, where the step of placing a leaf spring includes inserting the support tabs extending from the leaf spring into the spring slots through the open forward ends, and the step of assembling the housing includes closing the open forward ends of the spring slots with the front end component.

Alternatively, the front end component may have the spring slots, but with open aft ends, where the step of placing a leaf spring includes inserting support tabs extending from the leaf spring into the spring slots through the open aft ends, and the step of assembling includes closing the open aft ends of the spring slots with the back end component.

The passageway for a flat wiping contact may have a barrier wall obstructing a portion of the cross section of the passageway forward of the spring slots, which may limit forward motion of a contact in the passageway. It may further have a chin and hood structure forward of the barrier wall, where assembling the housing includes orienting the leaf spring so as to extend forward from said spring slots past barrier wall into the region of the chin and hood.

The forming of the front end component may include forming a mating face on the front end component configured as a multi-pole genderless connector mating face for mating with another similar multi-pole genderless connector mating face on another connector. There may be a genderless skirt structure extending forward from the mating face that cooperates with that on another connector to enclose the engaged contacts.

In yet another aspect, a genderless housing may include a straight-in and rotationally connectible genderless housing with a particular depth of engagement, where the hood is a partition configured with sidewall clearance for a chin of an opposing rotationally connectible genderless housing moving thorough an arc of motion during a rotational connecting motion.

In an additional aspect of the invention, there is provided a connector shell for flat wiping electrical contacts that has a back end component with at least one backside opening for an electrical conductor; a front end component with at least one frontside opening for exposing a flat wiping electrical contact; at least one leaf spring with support tabs extending from the sides thereof, suitable for operating a flat wiping electrical contact. The back end component is joined to the front end component as a unitary housing so as to define between the backside opening and the frontside opening a passageway with sidewalls with opposing spring slots recessed in the side walls, a barrier wall forward of the spring slots, and a chin and hood forward of said barrier wall. The support tabs extending from the leaf spring are retained in a fixed position by the spring slots and the leaf spring extends forward from there past the barrier wall. The parting line defined by the joined back end component and front end component intersects the spring slots. The back end and front end components are secured together by any of interference fit, snap lock fit, mechanical fastener, adhesive, welding, or other common or novel means.

In still another aspect, the invention extends to a method for making and breaking a flat wiping contact electrical connection by using two electrical connectors configured with housings having mating faces each having at least one chin and partition between which is exposed a contact surface of a flat wiping electrical contact, where the partitions on each connector are configured with radius of rotation clearance in a plane of rotation coplanar to the plane of the contact surface, for the path of travel of the respective chin of the other connector. The two electrical connectors are hingedly joined at an axis of rotation proximate the midpoint plane of the mating surfaces at full engagement, at a radius of rotation of at least the depth of engagement of the mating surfaces. A rotational opening or closing motion is applied as between the connectors about said axis of rotation so as to move the connectors between full engagement and an open position. The method extends to attaching each said connector to a respective support structure; hingedly joining the support structures; and applying a rotational motion to one support structure relative to the other.

This method may extend to making each of the two electrical connectors by the steps previously and elsewhere herein described, which include: forming a back end component with at least one backside opening for an electrical conductor; forming a front end component with at least one frontside opening with a chin and a partition; placing at least one leaf spring suitable for operating a flat wiping electrical contact between back end and front end component; assembling the back end to the front end component so as to define at least one passageway with sidewalls with opposing spring slots recessed in the side walls, with a barrier wall forward of said spring slots, and with chin and partition forward of the barrier wall. Support tabs extending from the leaf spring are retained in the spring slots, which extend forward past said barrier wall. The back end and front end components are secured or attached or otherwise bonded together by use of an interference fit, snap lock fit, mechanical fastener, adhesive, or welding, or the like. A flat wiping contact, which may be preconfigured to terminate a conductor, is inserted into the backside opening of the passageway and forward until it snaps onto the forward end of the leaf spring with its contact surface exposed at the front side opening between the chin and said partition.

Other aspects, objects and advantages will be readily apparent to those skilled in the art from the figures, written description and claims that follow.

### BRIEF DESCRIPTION OF THE DRAWINGS

FIG. 1A is a cut away view of a single pole housing of the prior art, revealing the passageway within which is seen the spring slot and stake, barrier wall, chin and hood, with a leaf spring installed.

FIG. 1B is the housing of FIG. 1A, with a flat wiping contact installed.

FIGS. 2A-2C are cross section illustrations of a two part, single pole connector housing similar to FIG. 1, with dashed lines showing examples of where a parting line may be applied to divide the housing into a front end component and a back end component.

FIG. 3 is a perspective, exploded view showing the front end component and back end component of a circular, 4 pole connector housing embodiment of the invention.

FIG. 4 is a perspective, exploded view showing the front and back end components of a two row, multi-conductor housing embodiment of the invention with a planar interface or parting line of front end to back end as evidenced by the flat front face on the back end component.

FIG. 5 is a perspective exploded view showing the front and back end components of a multi-pole connector housing embodiment having two diagonally disposed flat wiping contacts and room for one or two other types of contacts, such as pin and socket.

FIG. 6 is a perspective view showing the front and back end components of FIG. 5 housing assembled, and revealing the wings extending from the back end component by which the connector housing may be snap mounted into an opening in a panel.

FIG. 7 is a perspective, exploded view of the front and back end components of a two by four array, multi-conductor connector housing, the front end component shown cut away to reveal the channels or passageways into which the structure and springs extending from the back end component are received.

FIG. 8 is a perspective, sectioned view of the assembled connector housing of FIG. 7, revealing the channels or passageways through the connector, and the installed springs which will retain and operate the flat wiping contacts when they are later inserted through the back end component and locked into their respective conductor passageways.

FIG. 9 is a schematic view perpendicular to the plane of the arc of rotation of a pair of the rotationally connectible connectors of FIG. 8, for explaining arc and radius of rotation, depth of engagement, required clearances of mating structure, and related aspects of rotational closure of flat wiping contact connectors.

FIG. 10 is a front end view of a pair of prior art, genderless, single pole, flat wiping, one piece housing, straight-in connecting connectors.

FIG. 11 is a front end view of a pair of genderless, single pole, flat wiping, rotationally connectable, front and back two part housing connectors, with hood clearances for the closing radius of respective chin structures.

### DETAILED DESCRIPTION OF INVENTION

The invention is susceptible of many embodiments. What is described and illustrated herein is intended to be illustrative, but not limiting, of the scope of the invention and the appended claims.

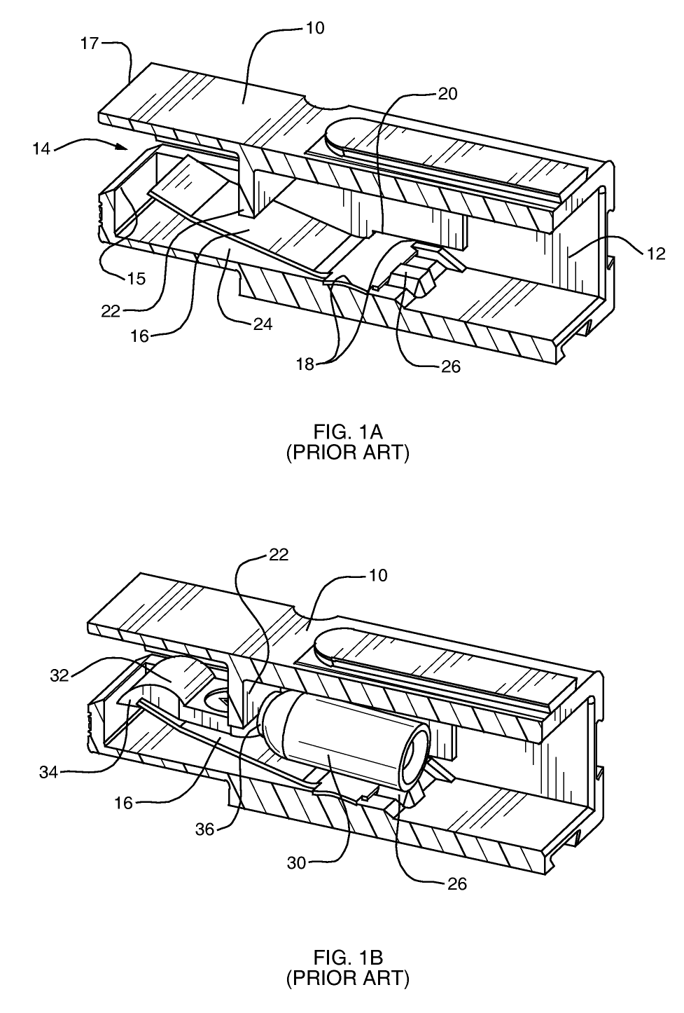

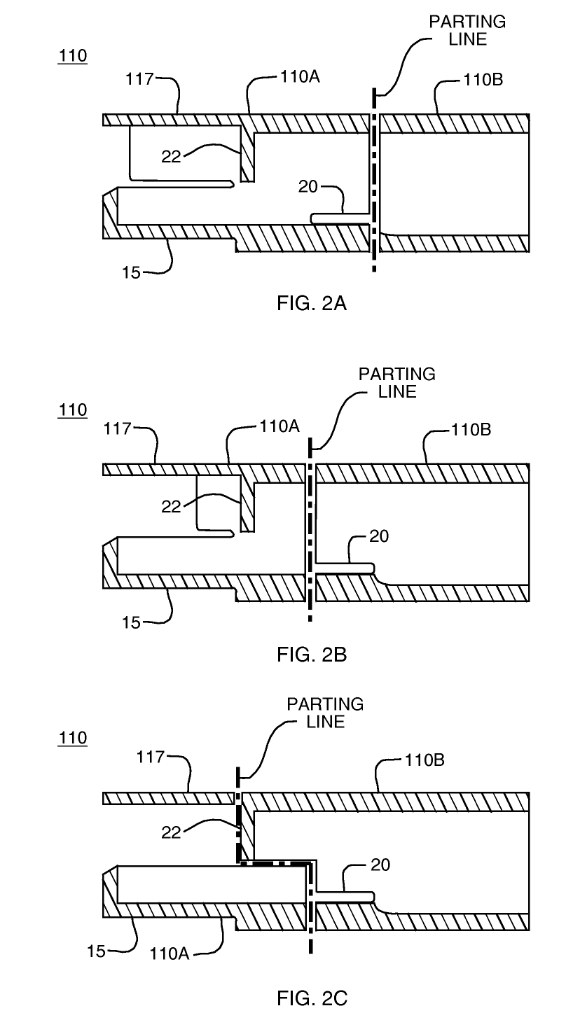

Three aspects of three embodiments of the invention are represented in the diagrammatic cross section views of the single pole connector housings of FIGS. 2A, 2B, and 2C, where selected reference numbers from FIG. 1 are used again for analogous elements of structure. The single pole example is used to simplify the explanation; the principles extend to multi-pole embodiments, as will be further illustrated by other figures. Each of these connector housing 110 examples is similar to the housing 10 of FIG. 1 except for three principle points.

First, each of the FIG. 2 examples is configured with captive spring slots 20, meaning that the slot is not continued forward or aft in the passageway to a point permitting simple insertion of a leaf spring 16 from either the front end or the back end of the housing, as in the spring slot 20 of prior art FIG. 1 case which is accessible through the backend opening.

Second, in each of the FIG. 2 examples, a parting line perpendicular to the longitudinal axis of the housing 110 is arranged to divide the housing into a front end component 110A with chin 15 and partition 117, and a back end component 110B. The housing is molded as two components with an interface defined by the parting line. Notice in FIG. 2A that the parting line intersects the aft end of slot 20. This enables a leaf spring 16 to be inserted into the open aft end of slot 20 in the back of front end component 10A, and the two housing components then brought together along the parting line to capture the spring in the slot. In the example of FIG. 2B, the parting line intersects the forward or front end of slot 20. This enables a leaf spring 16 to be inserted into the open front end of slot 20 in back end component 10B, and the two housing components then brought together along the parting line to capture the spring in the slot. In the example of FIG. 2C, the parting line again intersects the front end of slot 20. However in this instance, the parting line is stepped so as to include the structure of barrier wall 22 as integral to back end component 10B.

It will be apparent that any parting line perpendicular to the axis of the housing, either planar or stepped as in FIG. 2C, or otherwise configured to split the full housing into front and back parts at a point that intersects slot 20 any where along its length so as to open it for insertion of a leaf spring 16, enables the front and back end components 10A and 10B to be assembled with a spring 16 between them secured in slot 20. Multi-pole connectors may have a more complex interface geometry or parting line as between the front and back side components, but the principles with respect to individual contacts and their spring slots will conform to what is described here.

Third, in distinction to the genderless front end 12 of housing 10 of FIG. 1, in which hood 17 is U-shaped to align and capture an opposing chin during connecting; the analogous structure of housing 110 of FIG. 2A has a partition 117 that has foreshortened “sides” that provide a degree of clearance to the arc of radius of an opposing chin when two such connectors are rotationally connected over an arc of rotation. The embodiment of FIG. 2B has yet further foreshortened sides to partition 117; and partition 117 of the embodiment of FIG. 2C has no sides at all, but is planar, offering no interference with rotational closure at even a very short radius. This aspect of the invention will be discussed further later in this disclosure.

There may be additional keying structures or features incorporated into the chin, hood or partition, or elsewhere in the structure, that are not shown in these figures, for aligning the front and back end components upon assembly. Because there is no staking requirement or equivalent locking feature external of the spring slots, according to the invention, there may be more complex multi-contact connectors with regular or irregular arrays of contacts, for example: 1×2, 2×1, 2×2, 2×3, 3×2, 2×4, 4×2, or 3 rows by 3 columns and so on. The configuration of the parting line defining the front/back component interface may take into account other factors such as the external shape of the multi-contact housing, or mixing and matching of flat wiping contacts with other contact types. There may be molded in or masking on the front end component 110A of selected passageways or front openings 14 for isolation or keying benefits. There may be intentional omission of passageways or other modifications to the back end component 110B, or mixing and matching of different front end components with common back end components or vice versa, for the same or similar reasons.

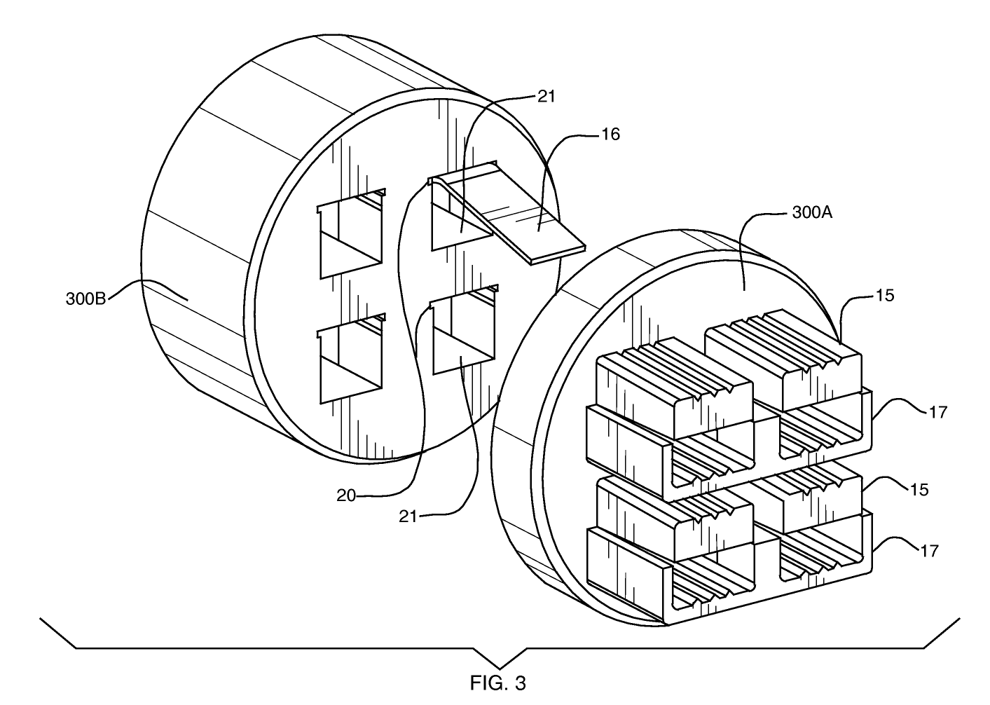

Referring to FIG. 3, one embodiment of the invention is a circular 4 pole connector housing containing a 2×2 array of contacts substantially as described in FIG. 2B, with a planar parting line between front end component 300A and back end component 300B, that intersects the front end of slots 20 in passageway 21. Barrier wall 22 for each contact (not visible in these views) is integral to each passageway in front end component 300A. Front end component 300A and back end component 300B may be keyed for easy assembly after springs 16 are put in place between them. Chins 15 and hoods 17 are apparent on the face of front end component 300A, indicating that this genderless connector configuration requires a straight-in connecting motion.

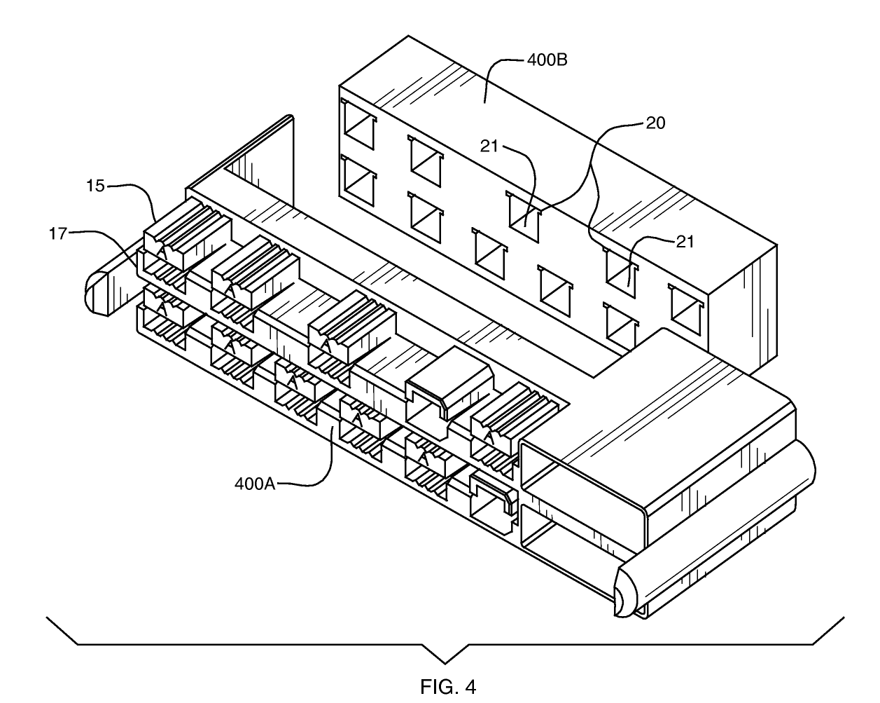

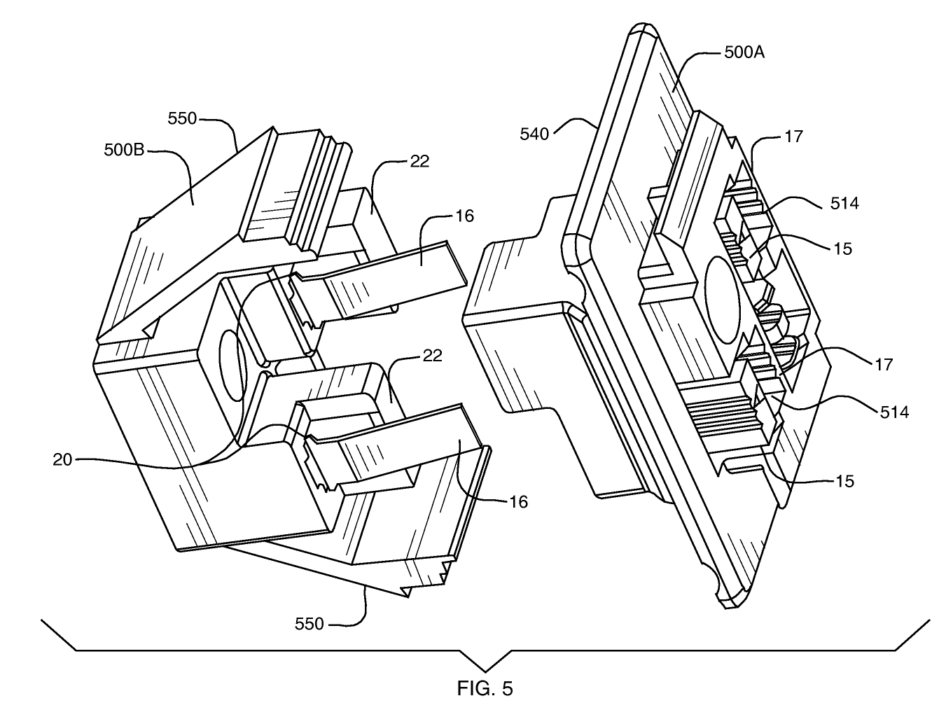

Referring now to FIG. 4, another embodiment is illustrated, having a non-genderless, irregular 5 over 6 conductor array in a single connector housing assembly. Front end component 400A has a planar parting line with back end component 400B with respect to the cross section area of the conductors, intersecting the forward end of slots 20 in passageways 21 as in FIG. 2B. Front end component 400A is further configured with peripheral or skirt-type structure extending rearward of the parting line which supports alignment during the front to back assembly process. Barrier wall 22 for each contact is internal (not shown) to front end component 400A. The front face exhibits chin 15 and hood 17 structure.

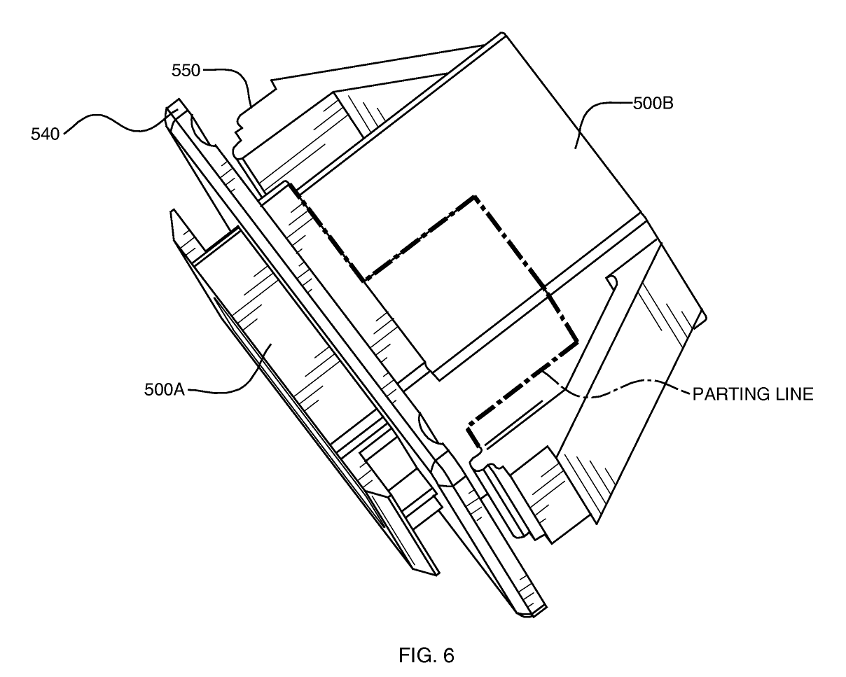

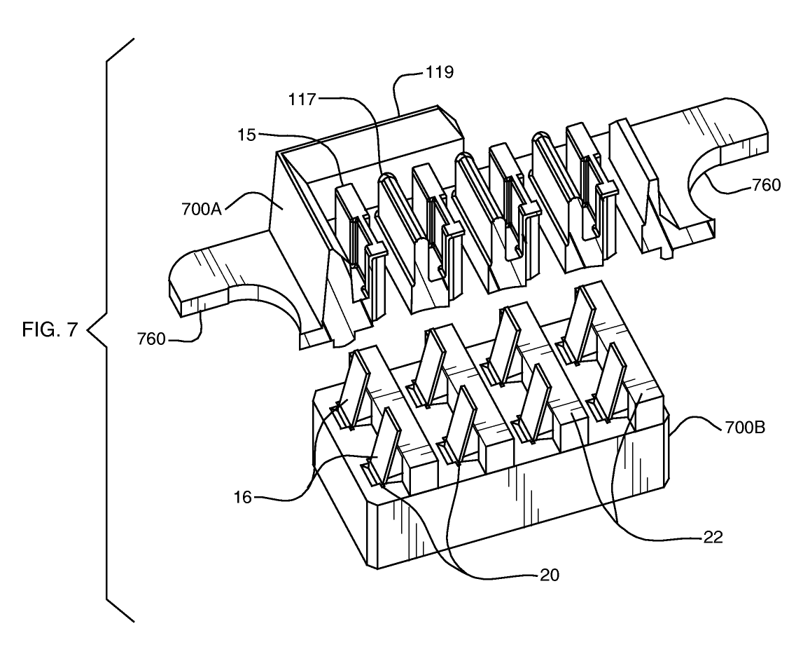

Referring now to FIGS. 5 and 6 a more complex but non-genderless embodiment of the invention is illustrated. Front end component 500A reveals a 2×2 conductor array potential but is provisioned for two diagonally placed flat wiping contacts with front openings 514 having respective chins 15 and hoods 17, and a forth corner is a circular opening that may accept a pin and socket or fit, form, function connector type. Back end component 500B is similarly provisioned for two flat wiping contacts as evidenced by spring slots 20 in which have been placed springs 16, and integral barrier walls 22. It will be readily apparent that the parting line for each of the two diagonally disposed flat wiping contacts is similar to that of FIG. 2C. However the remaining surface area of the front to back interface or parting line between front end component 500A and back end component 500B is further stepped for the remaining two corners to accommodate other conductor types or other considerations. Furthermore, front end component 500A is configured with mounting flange 540 for panel mounting of the assembled connector, and back end component 500B is configured with snap action fastener wings 550 for securing the assembled connector at the backside of the panel (not shown).

Referring to FIG. 6 in particular, there is shown a perspective view of the assembled housing of FIG. 5, with the parting line illustrated by a bold dashed line, and panel mounting flange 540 and snap action fastener wings 550 in close proximity, allowing a simple push-in installation of the connector into a suitable opening in a panel.

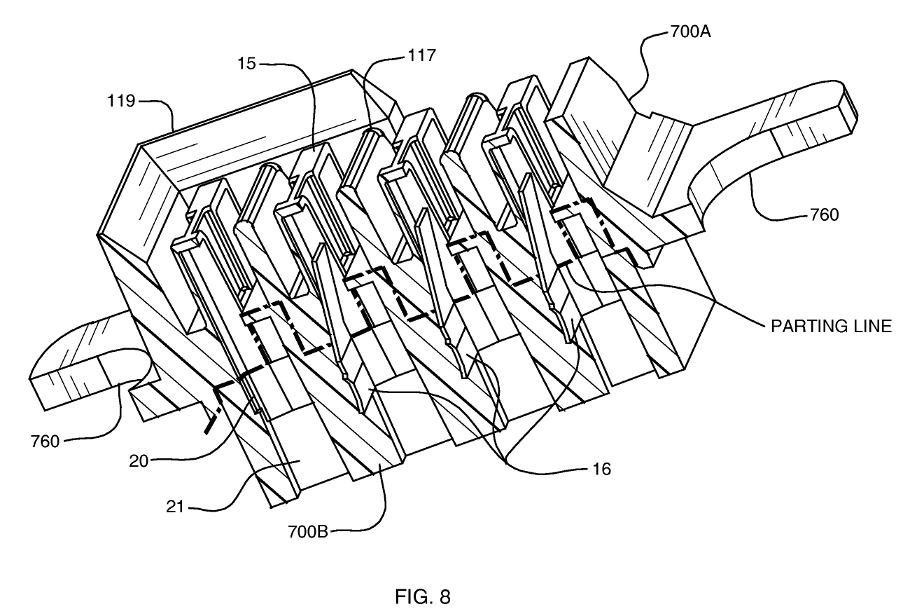

Referring now to FIG. 7, for this 2×4 contact array, genderless connector housing embodiment there is shown a perspective, exploded view of the front end component 700A, sectioned in the near row of contact channels to show details, and back end component 700B; and in FIG. 8 an assembled view, sectioned again at the near row of contact channels for exposing the assembled connector and springs 16 installed in slots 20 in passageways 21, with contacts not yet installed. The back end component 700B in FIG. 7B reveals a stepped interface or parting line similar to the embodiment of FIG. 2C, where the parting line is stepped to include the barrier wall 22 for each contact passageway or channel, and intersects the front end of slots 20 so that springs 16 are seated in the back end component 700B for assembly. The front end component 700A is sectioned in FIG. 7 exposing the interior of its first row to reveal the channels or passageways into which the barrier wall 22 structure and springs 16 from the back end component 700B are received when the two housing components are assembled. Front end component 700A has mounting ears 760 by which the assembled connector of FIG. 8 may be mounted to a chassis, panel, or other suitable structure, normally but not necessarily after the contacts and conductor wires have been installed.

In all of these embodiments, the front and back end components can be joined by any common means including adhesives, ultrasonic welding, or mechanical snaps, latches or fasteners, be they integral or external to the joined housing components.

Referring again to FIG. 8, the individual contacts in the array all have the same rotational orientation or in other words their contact surfaces 32 would all be co-planar and facing in the same direction. The front face is configured with pairs of housing chins 15 alternating with petitions 117, and with a connector skirt 119 extending along one end and half the length of the long side. The connector face is configured to be hermaphroditic or genderless; that is, two such connectors can be turned face to face, one rotated 180 degrees, and the two be mated, as is known in the industry. As is well understood by those in the art, the slightly offset chin structures of opposing connectors slide into close proximity during the connecting motion, essentially fully enclosing the contact area of each respective pair of engaged electrical contacts. The hoods or partitions 117 are interspersed in pairs with the mated pairs of chin structures, providing further lateral insulation and physical isolation of the electrical contacts. The skirts on the mating connectors cooperatively enclose the full array of connections, each extending around a respective one half of the array.

As previously explained, most connectors require a relatively straight-in connecting or plugging-in action, particularly flat wiping contact connectors, where both connectors are fully aligned face to face on a common axis for connecting. Keying is often provided with some level of depth or extension of the face to facilitate straight in alignment. With or without keying, it is often the case that single or multi-pole connectors are intolerant of careless or intentional off-angle attempts at mating or connecting, and to some extent of off-angle disconnecting or unplugging as well. This intolerance to off-angle connecting and disconnecting is a further problem to which the invention in some embodiments is directed.

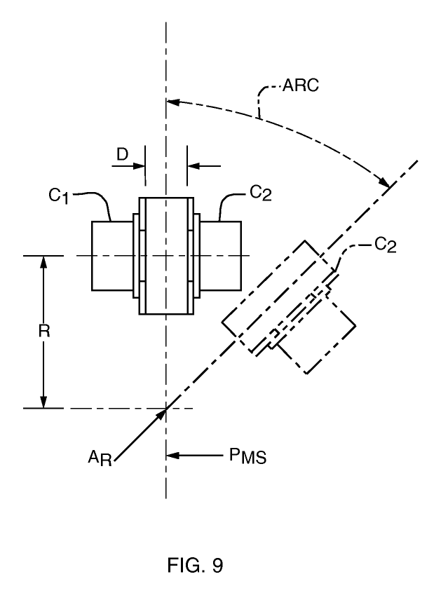

Referring now to FIG. 9, further aspects of the invention are explained by this simplified diagram where a pair of genderless, multi-conductor, flat wiping contact, rotationally connectible connectors C₁ and C₂, similar to that of FIGS. 7 and 8, but presumed to have one row of contacts, are shown in both connected and rotationally disconnected positions with dashed line ARC indicating a fixed angular path of motion for connecting and disconnecting. The connectors when connected have a full depth of engagement D and may be presumed to be mounted on respective support structures, not shown, which are hingedly joined at an axis of rotation A_{R}. The axis of rotation is displaced by radius R from the nearest contact, and is located in or parallel and proximate to the midpoint plane P_{MF} of their mated faces. Midpoint means with respect to the depth of engagement.

Rotational closure with a relatively small radius, which is normally desirable, is where the problem is most acute. The depth of engagement of the connectors is a significant factor. The greater the depth of engagement, the greater the variation in radius from the axis of rotation is for different points on the mating structures. For a protruding structure such as a chin or hood of a flat wiping contact mating structure during a rotational closing motion, if the axis of rotation is taken to be in the midpoint plane of full engagement then the variation in radius is least. If the axis of rotation is displaced from the midpoint plane, the variation in radius of motion of the tip of a chin as compared to the base of a chin may be significant, especially compared to normal tolerances between chins and hoods for straight in connections.

The mating chins form the primary enclosure for the electrical contacts. If clearance between chin and hood for rotation is needed for rotational closure, while straight in connection capability is also to be maintained, clearance must be provided by or at the hood structure to receive the mating connector chin.

It will be clear from the description of FIGS. 2A, 2B and 2C and other of the rotationally connectible embodiments that for a given depth of engagement, the smaller the radius R of rotational closure, the larger the D/R ratio is, and the more clearance will be needed on the sides of partition 117 to accommodate the path of travel of the opposing chin in its path of travel over it arc of rotation as the connector faces mesh into engagement.

The arrangement illustrated and described above requires a rotational motion for opening and closing the electrical connection by moving the connectors together and apart over an arc of motion ARC defined by nominal radius R, the distance between point A_{R} and the vertical center of the connectors at full engagement. As is readily apparent, the relative rotational motion of the supporting structure to which they are attached, about the axis of rotation A_{R}, will open and close C₁ and C₂ with a substantially frontal engagement of opposing wiping contacts and a fully aligned final full depth of connection. The connectors C1 and C2 remain fully capable of straight-in connecting motion as well, providing flexibility to various applications and installations.

In other embodiments and applications, the axis of rotation and supporting structure may be integral to a connector set. Flat wiping contacts oriented with the plane of rotation are best suited for dual use as rotational and/or straight in connecting action, although other contact types may be included in flat wiping, multi-pole connector arrays. In all cases, structural clearance for the arc of rotation as for rotationally mating connectors as well as straight-in mating connectors, of the contacts and the insulating structures must be provided.

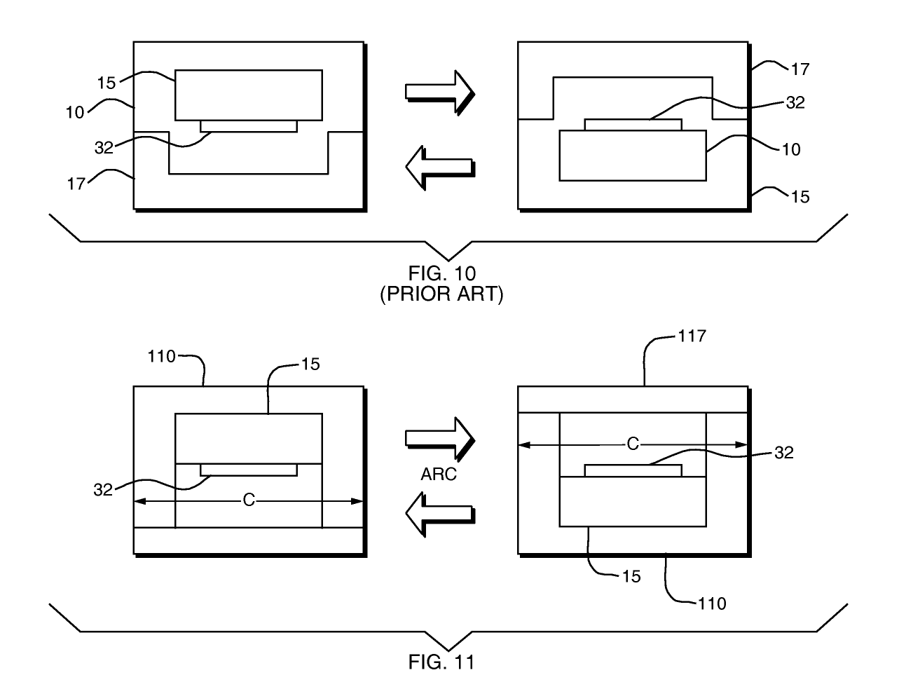

By way of example, referring now to FIGS. 10 and 11, a front elevation view of a pair of the prior art genderless, flat wiping contact, single pole connector housings 10 of FIG. 1 is shown in FIG. 10; one rotated 180 degrees as would be for mating. Chins 15 and U-shaped hoods 17 show that the design is clearly intended for and limited to a straight-in connecting action, and they cannot be otherwise mated.

In contrast, a front elevation view of a pair of genderless, straight-in or rotationally connectible, two part front and back, housing 110 of the invention is shown in FIG. 11, where chins 15 and planar partitions 117 illustrate that clearance is provided for a rotational connecting motion between the two connectors as illustrated and described in regard to FIGS. 2 and 9, where the radius of the chins in their respective arcs of rotation into engagement would find interference if the connector faces where configured with U-shaped hoods 17.

Referring back to FIG. 8, the same principle is extended to this genderless, rotationally connectible, two part front and back end component connector assembly, in that partitions 117 on the face of front end component 700A, and skirts 119 as well, are configured so as to provide clearance for rotational closure as described in FIG. 9. Other embodiments, including but not limited to the two part front and back end component connector of FIG. 3 may be configured on its face with clearance for rotational closure.

Whether single or multi-contact embodiments, all may use a straight-in connecting motion or, in the plane of their wiping contact surfaces, any radius of closing rotation larger than the design minimum radius for which clearances and tolerances have been provided. Other configurations of multi-pole, genderless connectors may be similarly configured for rotational connecting motion.

These embodiments are not exhaustive of the scope of the invention. Other embodiments and variations of the invention within the scope of the claims or equivalent to them will be readily apparent to those skilled in the art.

We claim:

1. A method for assembling a connector shell for flat wiping electrical contacts comprising the steps:
forming a back end component with at least one backside opening for an electrical conductor;
forming a front end component with at least one frontside opening for exposing a flat wiping electrical contact;
placing at least one leaf spring suitable for operating a said flat wiping electrical contact between said back end component and said front end component; and
assembling said back end component to said front end component into a unitary housing so as to define between the backside opening and the frontside opening a passageway with sidewalls with opposing spring slots recessed in the side walls, a parting lining between said front end component and said back end component intersecting said spring slots, and wherein supporting tabs extending from said leaf spring are retained in said spring slots.

2. The method of claim 1, said assembling of said components into said unitary housing comprising securing the back end and front end components together by at least one from among the group of means of securing comprising: interference fit, snap lock fit, mechanical fastener, adhesive, and welding.

3. The method of claim 2, said components comprising keying structure for assembly, said step of assembling comprising using said keying structure for aligning said components.

4. The method of claim 2, said back end component comprising the spring slots, the spring slots being configured with open forward ends, said step of placing a leaf spring comprising inserting support tabs extending from said leaf spring into said spring slots through the open forward ends, said step of assembling comprising closing the open forward ends of said spring slots with said front end component.

5. The method of claim 2, said front end component comprising the spring slots configured with open aft ends, said step of placing a leaf spring comprising inserting support tabs extending from said leaf spring into said spring slots through the open aft ends, said step of assembling comprising closing the open aft ends of said spring slots with said back end component.

6. The method of claim 2, said passageway comprising a barrier wall in said passageway forward of said spring slots, and a chin and hood forward of said barrier wall, assembling said housing comprising orienting said leaf spring so as to extend forward from said spring slots past said barrier wall.

7. The method of claim 6, said forming said front end component comprising forming a mating face on said front end component configured as a multi-pole genderless connector mating face for mating with another like said multi-pole genderless connector mating face.

8. The method of claim 7, said forming said front end component further comprising forming a genderless skirt extending forward from said mating face.

9. The method of claim 7, said genderless housing comprising a straight-in and rotationally connectible genderless housing with depth of engagement D, said hood comprising a partition configured with sidewall clearance for a chin of an opposing said rotationally connectible genderless housing moving thorough an arc of motion of radius R during a rotational connecting motion.

10. The method of claim 8, wherein R is greater than D.

11. A method for assembling a connector shell for flat wiping electrical contacts comprising the steps:
forming a back end component with at least one backside opening for an electrical conductor;
forming a front end component with at least one frontside opening for exposing a flat wiping electrical contact;
placing at least one leaf spring suitable for operating a said flat wiping electrical contact between said back end component and said front end component;
assembling said back end component to said front end component into a unitary housing so as to define between the backside opening and the frontside opening a passageway with sidewalls with opposing spring slots recessed in the side walls, a barrier wall forward of said spring slots, and a chin and hood forward of said barrier wall, wherein support tabs extending from said leaf spring are retained in said spring slots and said leaf spring extends forward therefrom past said barrier wall, said housing further comprising a parting line where the back end and front end components meet; and
securing the back end and front end components together by at least one from among the group of means of securing comprising: interference fit, snap lock fit, mechanical fastener, adhesive, and welding.

12. The method of claim 11, said components comprising keying structure for assembly, said step of assembling comprising using said keying structure for aligning said components.

13. The method of claim 11, said back end component comprising the spring slots, the spring slots being configured with open forward ends, said step of placing a leaf spring comprising inserting said support tabs extending from said leaf spring into said spring slots through the open forward ends, said step of assembling comprising closing the open forward ends of said spring slots with said front end component.

14. The method of claim 1, said front end component comprising the spring slots configured with open aft ends, said step of placing a leaf spring comprising inserting the support tabs extending from said leaf spring into said spring slots through the open aft ends, said step of assembling comprising closing the open aft ends of said spring slots with said back end component.

15. The method of claim 11, said forming said front end component comprising forming a mating face on said front end component configured as a multi-pole genderless connector mating face for mating with another like said multi-pole genderless connector mating face.

16. The method of claim 15, said housing comprising a rotationally connectible genderless housing, said hood comprising a partition configured with sidewall clearance for a chin of an opposing said rotationally connectible genderless housing moving thorough an arc of motion during a rotational connecting motion.

17. A connector shell for flat wiping electrical contacts comprising:
a back end component with at least one backside opening for an electrical conductor;
a front end component with at least one frontside opening for exposing a flat wiping electrical contact;
at least one leaf spring with support tabs extending from the sides thereof, suitable for operating a said flat wiping electrical contact;
said back end component being joined to said front end component as unitary housing so as to define between the backside opening and the frontside opening a passageway with sidewalls with opposing spring slots recessed in the side walls, a barrier wall forward of said spring slots, and a chin and hood forward of said barrier wall, wherein said support tabs extending from said leaf spring are retained in a fixed position by said spring slots and said leaf spring extends forward therefrom past said barrier wall, the parting line defined by the joined back end component and front end component intersects the spring slots; and
said back end component being secured to said front end component by at least one from among the group of means of securing comprising: interference fit, snap lock fit, mechanical fastener, adhesive, and welding.

18. A method for making and breaking a flat wiping contact electrical connection comprising the steps:
using two electrical connectors configured with housings having mating faces each comprising at least one chin and partition between which is exposed a contact surface of a flat wiping electrical contact, said partitions on each said connector being configured with radius of rotation clearance in a plane of rotation coplanar to the plane of the contact surface, for the path of travel of the respective chin of the other said connector;
hingedly joining the two electrical connectors at an axis of rotation proximate the midpoint plane of the mating surfaces at full engagement, at a radius of rotation of at least the depth of engagement of the mating surfaces; and
applying a rotational opening and closing motion to said connectors about said axis of rotation so as to move said connectors between said full engagement and an open position.

19. The method of claim 18, further comprising:
attaching each said connector to a respective support structure; said hingedly joining the connectors comprising hingedly joining the support structures; said applying a rotational opening and closing motion to said connectors comprising applying a rotational motion of one said support structure to the other.

20. The method of claim 18, further comprising making each of two said electrical connectors by the steps of:
forming a back end component with at least one backside opening for an electrical conductor;
forming a front end component with at least one frontside opening with a said chin and a said partition;
placing at least one leaf spring suitable for operating a said flat wiping electrical contact between said back end component and said front end component;
assembling said back end component to said front end component into a unitary housing so as to define between the backside opening and the frontside opening a passageway with sidewalls with opposing spring slots recessed in the side walls, a barrier wall forward of said spring slots, with said chin and said partition positioned forward of said barrier wall, wherein support tabs extending from said leaf spring are retained in said spring slots and said leaf spring extends forward therefrom past said barrier wall;
securing the back end and front end components together by at least one from among the group of means of securing comprising: interference fit, snap lock fit, mechanical fastener, adhesive, and welding; and
inserting a said flat wiping contact into the backside opening of said passageway and forward until it snaps onto the forward end of said leaf spring with its said contact surface exposed at the front side opening between said chin and said partition.
